(19) United States
(12) Patent Application Publication
(10) Pub. No.: US 2017/0107144 A1
(43) Pub. Date: Apr. 20, 2017

(54) GLASS MEMBER AND MANUFACTURING METHOD OF GLASS MEMBER

(71) Applicant: Asahi Glass Company, Limited, Chiyoda-ku (JP)

(72) Inventors: Mitsuru HORIE, Chiyoda-ku (JP); Masabumi Ito, Chiyoda-ku (JP); Kazutomo Mori, Chiyoda-ku (JP)

(73) Assignee: Asahi Glass Company, Limited, Chiyoda-ku (JP)

(21) Appl. No.: 15/291,553

(22) Filed: Oct. 12, 2016

(30) Foreign Application Priority Data
Oct. 16, 2015 (JP) 2015-204551

(51) Int. Cl. C03C 17/02; C03C 21/00

(52) U.S. Cl. CPC C03C 17/02; C03C 21/002; C03C 2217/732; C03C 2217/78; C03C 2218/112

(57) ABSTRACT

A glass member includes a glass plate, on a first surface of which a functional layer is formed. A Martens hardness measured from a side of the functional layer of the glass member is 1100 N/mm² or more. The functional layer includes silica. A cut level difference RΔc obtained from a roughness curve for a surface of the functional layer is 2% or more. The cut level difference RΔc is obtained by subtracting a load length ratio for a cut level of 10%, Rmr(10), from the load length ratio for the cut level of 50%, Rmr(50). The load length ratio for the cut level c is obtained by formula

$$Rmr ( c ) = \frac{1}{L} {\sum }_{i = 1}^{n} {M ( c )}_{i} \times 100$$

where M(c)ᵢ is a cut length of an i-th cut portion. By cutting the roughness curve at the cut level c within a region having a length L, n cut portions are obtained.

### CROSS-REFERENCE TO RELATED APPLICATION

The present application claims benefit of priority under 35 U.S.C. §119 of Japanese Patent Application No. 2015-204551 filed on Oct. 16, 2015. The contents of this application are incorporated herein by reference in their entirety.

### BACKGROUND OF THE INVENTION

1. Field of the Invention

The present invention relates to a glass member and a manufacturing method of the glass member.

2. Description of the Related Art

Conventionally, forming functional layers, such as anti-glare films or low-reflection films, on surfaces of glass plates to produce glass members has been known. Such glass members are applied to, for example, cover glass of touch panel type devices.

The functional layers on the glass members are formed by, for example, applying application liquid including silica precursor on glass plates and desiccating or burning the application liquid. For example, when a material of low reflection is added to the application liquid, a low-reflection film is formed on the glass plate. Moreover, when application liquid is applied so that irregularity is formed on a surface of a glass plate, an anti-glare film is formed on the glass plate (See Patent Document 1).

### Patent Document

### [Patent Document 1] Japanese Unexamined Patent Application Publication No. 2011-88765

When the inventors of the present application touched surfaces of conventional glass members (surfaces of a side of functional layers), the inventors often felt gritty and found bad feeling of touch. However, when some treatment is offered to the functional layers in order to improve the feeling of touch, possibility that a desired characteristic is not expressed in the functional layers can be raised this time.

The present invention is performed in view of this background. The present invention aims at providing a glass member that can obtain excellent feeling of touch without degrading the function expressed by the functional layers, and providing a method of manufacturing the same.

### SUMMARY OF THE INVENTION

In the present invention are provided a glass member, in which a functional layer is present on a first surface of a glass plate; a Martens hardness measured from a side of the functional layer of the glass member is 1100 N/mm² or more, the functional layer including silica; and a cut level difference RΔc obtained by the following method from a roughness curve for a surface of the functional layer is 2% or more.

Calculation Method of the Cut Level Difference RΔc:

In the roughness curve for the surface of the functional layer (evaluation length L is 10 mm), a cut level is denoted by c, in a load length ratio Rmr(c) expressed by the following formula (1)

$$\begin{matrix}[ Math 1 ] & \\ Rmr ( c ) ( \% ) = \frac{1}{L} {\sum }_{i = 1}^{n} M ( c ) i \times 100. & formula ( 1 )\end{matrix}$$

When the load length ratio for c=10% is denoted by Rmr(10), and the load length ratio for c=50% is denoted by Rmr(50), the cut level difference RΔc is RΔc expressed by the following formula (2)

RΔc(%)=Rmr(50)−Rmr(10). formula (2)

Moreover, in the present invention, a manufacturing method of a glass member includes

(1) a step of applying application liquid on a first surface of a glass plate to form a functional layer including silica, and making a cut level difference RΔc obtained by a following method from a roughness curve for a surface of the functional layer less than 2%; and

(2) a step of polishing the surface of the functional layer, and making the cut level difference RΔc obtained by the following method from the roughness curve for the surface of the functional layer 2% or more.

Calculation Method of the Cut Level Difference RΔc:

In the roughness curve for the surface of the functional layer (evaluation length L is 10 mm), the cut level is denoted by c, in a load length ratio Rmr(c) expressed by the following formula (3)

$$\begin{matrix}[ Math 2 ] & \\ Rmr ( c ) ( \% ) = \frac{1}{L} {\sum }_{i = 1}^{n} M ( c ) i \times 100 & formula ( 3 )\end{matrix}$$

where the load length ratio for c=10% is denoted by Rmr(10), and the load length ratio for c=50% is denoted by Rmr(50), the cut level difference RΔc is RΔc expressed by the following formula (4)

RΔc(%)=Rmr(50)−Rmr(10). formula (4)

### Effect of Invention

According to the aspect of the present invention, a glass member that can obtain excellent feeling of touch without degrading the function expressed by the functional layers, and a method of manufacturing the same can be provided.

### BRIEF DESCRIPTION OF THE DRAWINGS

Other objects, features and advantages of the present invention will become more apparent from the following detailed description when read in conjunction with the accompanying drawings.

FIG. 1 is a diagram schematically depicting a roughness profile of a functional layer (left) and a relation between a cut level c (%) and a load length ratio Rmr(c) (%) (right);

FIG. 2 is a diagram schematically depicting a cross section of a glass member according to an embodiment;

FIG. 3 is a flowchart schematically depicting a flow of a manufacturing method for the glass member according to the embodiment;

FIG. 4 is a diagram depicting an example of a surface roughness profile of the functional layer formed in a step of the manufacturing method for the glass member according to the embodiment;

FIG. 5 is a diagram schematically depicting an example of a polishing apparatus used for polishing a surface of the functional layer;

FIG. 6 is a diagram depicting an example of the surface roughness profile of the functional layer formed in a step of the manufacturing method for the glass member according to the embodiment;

FIG. 7 is a diagram depicting a surface microscope photograph of an anti-glare film according to a first sample;

FIG. 8 is a diagram depicting a surface roughness profile of the anti-glare film according to the first sample;

FIG. 9 is a diagram depicting a relation between a cut level c and a load length ratio Rmr(c) of the anti-glare film according to the first sample;

FIG. 10 is a diagram depicting a surface microscope photograph of an anti-glare film according to a second sample;

FIG. 11 is a diagram depicting a surface roughness profile of the anti-glare film according to the second sample;

FIG. 12 is a diagram depicting a relation between a cut level c and a load length ratio Rmr(c) of the anti-glare film according to the second sample;

FIG. 13 is a diagram depicting a surface microscope photograph of an anti-glare film according to a seventh sample;

FIG. 14 is a diagram depicting a surface roughness profile of the anti-glare film according to the seventh sample; and

FIG. 15 is a diagram depicting a relation between a cut level c and a load length ratio Rmr(c) of the anti-glare film according to the seventh sample.

### DETAILED DESCRIPTION OF THE PREFERRED EMBODIMENTS

An embodiment for implementing the present invention is described below by referring to the drawings.

Upon touching surfaces of conventional glass members (surfaces of a side of functional layers), the inventors often felt gritty and found bad feeling of touch.

Such bad feeling of touch may become a problem when glass member become popular in the future. For example, when the glass member is applied to a cover glass or the like of a touch panel type device, a user may feel a feeling of discomfort upon touch operation. Such touch panel lacks in appeal and may be avoided by users.

On the other hand, when some treatment is offered to the functional layers in order to improve the feeling of touch, possibility that a desired characteristic is not expressed in the functional layers can be raised this time. In particular, it is a fact that a relation between a property of the functional layer and the feeling of touch has been hardly examined. Therefore, there are almost no guidelines for improving feeling of touch of functional layers.

Under such circumstances, the inventors of the present application have found that when a functional layer includes silica and when a surface of the functional layer is controlled in a specific condition, an excellent feeling of touch can be obtained without degrading functions expressed by the functional layers.

Moreover, the inventors have found that because a glass member having such a functional layer is excellent at abrasion-resistance, the glass member can be significantly used also for a purpose such as a cover glass of a touch panel device.

That is, the present invention provides a glass member, in which a functional layer is present on a first surface of a glass plate, a Martens hardness measured from a side of the functional layer of the glass member is 1100 N/mm² or more, the functional layer includes silica, and when in a roughness curve for the surface of the functional layer (evaluation length is 10 mm), a cut level is denoted by c, in a load length ratio Rmr(c) expressed by the following formula (1)

$$\begin{matrix}[ Math 3 ] & \\ Rmr ( c ) ( \% ) = \frac{1}{L} {\sum }_{i = 1}^{n} M ( c ) i \times 100 & formula ( 1 )\end{matrix}$$

where the load length ratio with c=10% is denoted by Rmr(10), and the load length ratio with c=50% is denoted by Rmr(50), the cut level difference RΔc expressed by the following formula (2)

RΔc(%)=Rmr(50)−Rmr(10). formula (2)

is 2% or more.

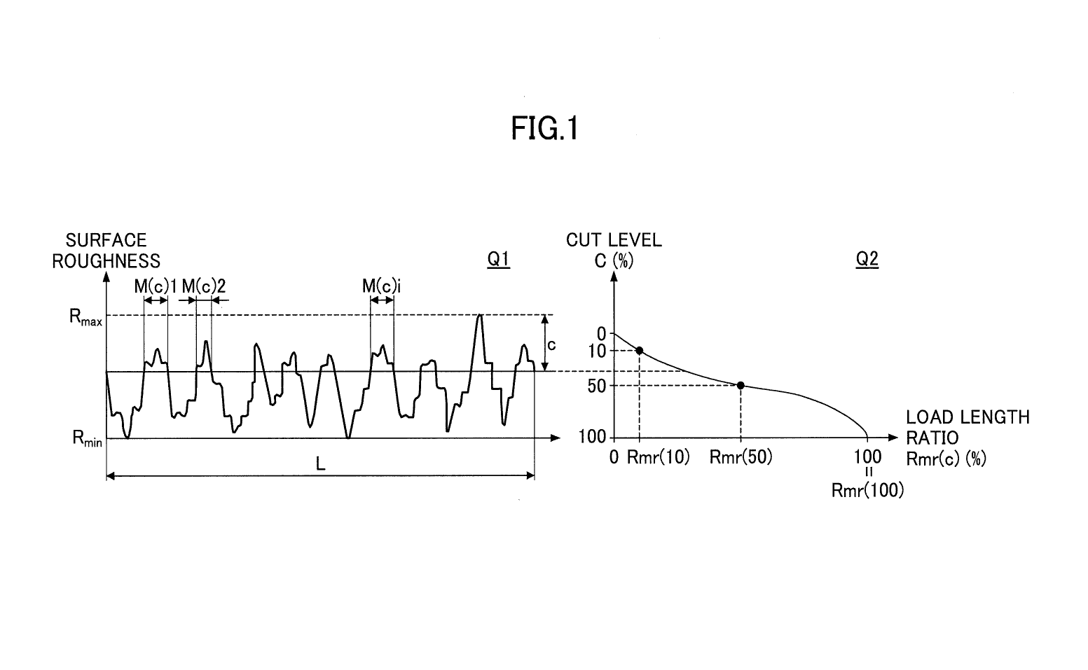

Here, referring to FIG. 1, the load length ratio Rmr(c) and the cut level difference RΔc will be described in detail.

FIG. 1 roughly depicts a schematic roughness profile of a functional layer and a relation between a cut level c and the load length ratio Rmr(c). A left part of FIG. 1 schematically depicts the roughness profile of the functional layer (a roughness curve for the surface), and a right part of FIG. 1 schematically depicts the relation between the cut level c and the load length ratio Rmr(c).

A surface roughness curve Q1 will be considered, in which the surface of the functional layer changes over the evaluation length L, from the highest part Rmax to the lowest part Rmin, as illustrated in the left part of FIG. 1.

When the surface having such surface roughness curve Q1 is virtually cut horizontally, along a cut level c (where 0%≦c≦100%) defined by a distance in the depth direction from the highest part Rmax, depending on a position of the cut level c, a part of a convex portion of the surface roughness curve Q1 is cut.

When lengths of cut regions of the convex portions in V) the horizontal direction are denoted in order from the left as M(c)₁, M(c)₂, . . . , M(c)ᵢ, . . . , M(c)ₙ, a sum of these lengths is a function of the evaluation length L and the cut level c. The function is will be referred to as a load length ratio Rmr(c). The load length ratio Rmr(c) is expressed by above-described formula (1).

In the present application, the evaluation length L in formula (1) is 10 mm.

Next, when the relation between the cut level c (5) and the load length ratio Rmr(c) is expressed, a load curve Q2 illustrated in the right part of FIG. 1 is obtained.

As is obvious from the load curve Q2, when the cut level c is 0%, the load length ratio Rmr(c) is zero. When the cut level c is 100%, the load length ratio Rmr(c) is 100%. In the region of 0%<c<100%, the load length ratio Rmr(c) can take a value of 0%<Rmr(c)<100% depending on the roughness profile.

Here, assume that the load length ratio Rmr(c) at the cut level c=10% will be denoted by Rmr(10), and the load length ratio Rmr(c) at the cut level c=50% will be denoted by Rmr(50). Moreover, as in above-described formula (2), a difference between these ratios will be defined as a cut level difference RΔc.

When the cut level difference is defined as above, the great cut level difference RΔc indicates that there are few great convex portions which deviate from an average concavity and convexity in the surface roughness curve Q1. On the other hand, the small cut level difference RΔc indicates that there are a lot of great convex portions that deviate from the average concavity and convexity, i.e. there are more than a few convex portions that are “spike-like” projected.

When a lot of such “spike-like” projected convex portions are present on the surface of the functional layer, the feeling of touch tends to become worse.

In the glass member according to the embodiment, on the surface of the functional layer, the cut level difference RΔc is relatively great (2% or more), few “spike-like” convex portions are present, and thereby a gritty feel is not particularly obtained when touching. Therefore, by the glass member according to the embodiment, the feeling of touch can be improved.

Moreover, in the glass member according to the embodiment, while in the functional layer the surface roughness profile is adjusted, regarding the characteristics, any adjustment that may cause adverse effect is not particularly performed.

Therefore, in the glass member according to the embodiment, an excellent feeling of touch can be obtained maintaining the function expressed by the functional layer.

(Glass Member According to the Embodiment)

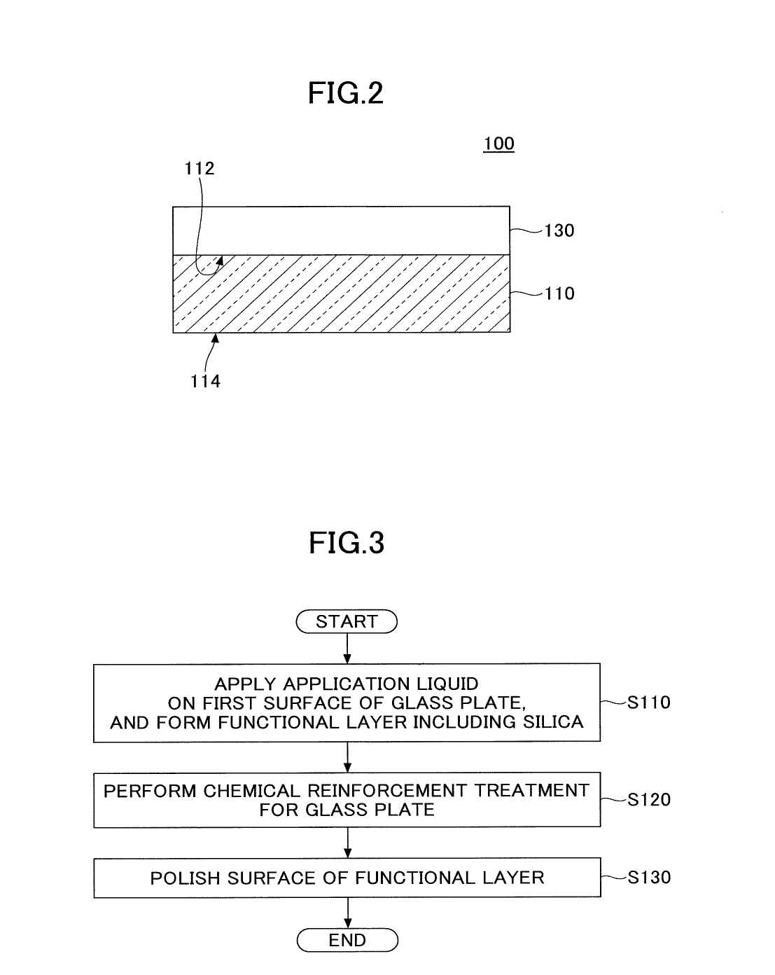

FIG. 2 schematically depicts a cross section of a glass member according to the embodiment (in the following, referred to as “first glass member”).

As illustrated in FIG. 2, the first glass member 100 includes a glass plate 110 and a functional layer 130.

The glass plate 110 includes a first surface 112 and a second surface 114, and the functional layer 130 is arranged on a side of the first surface 112 of the glass plate 110.

The glass plate 110 forms a base part of the first glass member 100. The glass plate 110 may be chemically strengthened.

The functional layer 130 is provided so as to cause the glass plate 110 to express a specific function. The functional layer 130 may be an anti-glare film, a low-reflection film or the like. The functional layer 130 includes a layer including silica. In particular, a contained amount of silica is preferably 50 mass % or more.

Here, in the first glass member 100, the functional layer 130 has a feature that the cut level difference RΔc expressed by above-described formula (2) is 2% or more.

According to such feature, in the first glass member 100, an excellent feeling of touch can be expressed, maintaining the function of the functional layer 130.

Moreover, a Martens hardness of the first glass member 100 measured from a side of the functional layer 130 is 1100 N/mm² or more. Therefore, the first glass member 100 can exert relatively excellent abrasion-resistance.

In the embodiment, the Martens hardness is a value measured in conformity with ISO 14577-1 (2002).

(Glass Member Configuration)

Next, specifications or the like of the respective members included in the first glass member 100 configuration, as illustrated in FIG. 2, will be described in detail.

(Glass Plate 110)

Dimensions, composition and the like of the glass plate 110 are not limited. The glass plate 110 may have a thickness of 0.1 mm to 10 mm, for example.

When the composition of the glass plate 110 includes alkali metal, the glass plate 110 may be subjected to chemically strengthening treatment.

Here, the “chemically strengthening treatment (method)” refers to a generic term of techniques in which a glass plate is immersed in molten salt including alkali metal, and an alkali metal ion with smaller atomic radius present on an outermost surface of the glass plate is replaced by an alkali metal ion with greater atomic radius present in the molten salt. In the “chemically strengthening treatment (method)”, on a surface of the treated glass plate, the alkali metal (ion) with greater radius than the original atom before the treatment is arranged. Therefore, a compression stress layer can be formed on the surface of the glass plate, and thereby the strength of the glass plate is enhanced.

For example, when the glass plate includes sodium (Na), in the chemically strengthening treatment, the sodium is replaced by, for example, potassium (K) in molten salt (for example, nitrate). Alternatively, when a glass substrate includes lithium, for example, in the chemically strengthening treatment, the lithium may be replaced by sodium (Na) and/or potassium (K) in molten salt (for example, nitrate).

The glass plate is provided with a compression stress layer on the surface by being subjected to an ion-exchange treatment. A surface compression stress (CS) on the glass plate that has been subjected to the ion-exchange treatment is preferably 200 MPa or more, and is more preferably 300 MPa or more, 400 MPa or more, 500 MPa or more, 600 MPa or more, 700 MPa or more, 800 MPa or more, 900 MPa or more, or 1000 MPa or more. According to the CS of 200 MPa or more, a flaw hardly occurs on the surface of the glass plate.

Moreover, a flaw with a depth that is greater than a depth of the compression stress layer (DOL), when the glass plate that has been subjected to the ion-exchange treatment is used, leads to breaking of the glass plate. Therefore, a value of DOL of the glass plate is preferably greater. The DOL is preferably 5 μm or more, and is more preferably 10 μm or more, 15 μm or more, 20 μm or more, 25 μm or more, 30 μm or more, or 40 μm or more. On the other hand, according to the DOL of 100 mm or less, chemically strengthened glass can be easily cut. The DOL is more preferably, 80 mm or less, and 50 mm or less.

(Glass Composition)

The glass plate 110 may be formed of soda lime glass, alumino-silicate glass, alumino-borosilicate glass, borosilicate glass, lead glass, alkali barium glass, alkali free glass and the like. Among them, alumino-silicate glass, alumino-borosilicate glass and soda lime glass are preferable, because they include sodium and can be strengthened by the chemically strengthening treatment.

In the following, a preferable composition of the glass plate 110 according to the embodiment will be described in detail.

SiO₂ is a component forming a framework of glass, and is a component for reducing an occurrence of a crack when a surface of the glass is damaged (indented) or reducing a rate of breakage when the surface is indented after the chemically strengthening treatment. In a composition indicated by mole %, according to SiO₂ of 56% or more, stability, acid resistance, weather resistance, or chipping resistance as glass is enhanced. SiO₂ is preferably 58% or more, and more preferable 60% or more. According to SiO₂ of 72% or less, viscosity of glass decreases and melting performance is enhanced, or the surface compression stress can be easily increased. SiO₂ is preferably 70% or less, and more preferably 69% or less.

Al₂O₃ is an effective component for enhancing the ion-exchange performance and the chipping resistance, a component for increasing the surface compression stress, or an essential component for decreasing a rate of occurrence of crack when indented by a 110° indenter. In a composition indicated by mole %, according to Al₂O₃ of 8% or more, by ion-exchange, a desired value of surface compression stress or compression stress layer thickness can be obtained. Al₂O₃ is more preferably 9% or more, and is further preferably 10% or more. According to Al₂O₃ of 20% or more, viscosity of glass decreases and homogeneous melting becomes easy, or acid resistance is enhanced. Al₂O₃ is more preferably 18% or less, further preferably 16% or less, and especially preferably 14% or less.

Na₂O is a component for forming a surface compression stress layer by the ion-exchange, and for enhancing melting performance of glass. In a composition indicated by mole %, according to Na₂O of 8% or more, a desired surface compression stress layer can be formed easily by the ion-exchange. Na₂O is more preferably 9% or more, further preferably 10% or more, and especially preferably 11% or more. According to Na₂O of 25% or less, the weather resistance or the acid resistance is enhanced, and a crack hardly occurs from an indentation. Na₂O is more preferably 22% or less, and further preferably 21% or less. When the acid resistance is especially desired to be enhanced, Na₂O is preferably 17% or less, and more preferably 16.5% or less.

In a composition indicated by mole %, a contained amount of B₂O₃ is preferably 0.5% or more, more preferably 1% or more, 2% or more, 3% or more, and 4% or more. According to B₂O₃ of contained amount of 1% or more, chemically strengthened glass can be obtained which is excellent in balance of face strength and transmissivity, is provided with features of both low brittleness and high hardness, and can be easily processed by a chemical such as acid. The contained amount of B₂O₃ is preferably 20% or less, is more preferably 15% or less, 10% or less, 8% or less, and 6% or less. According to the contained amount of B₂O₃ of 20% or less, acid resistance is prevented from being extremely small.

More specifically, for example, the following compositions of glass are given:

(i) Glass including, in a composition indicated by mole %, SiO₂ of 50 to 80%, Al₂O₃ of 2 to 25%, Li₂O of 0 to 10%, Na₂O of 0 to 18%, K₂O of 0 to 10%, MgO of 0 to 15%, CaO of 0 to 10% and ZrO₂ of 0 to 5%; and
(ii) Glass including, in a composition indicated by mole %, SiO₂ of 56 to 72%, Al₂O₃ of 8 to 20%, B₂O₃ of 3 to 20%, Na₂O of 8 to 25%, K₂O of 0 to 5%, MgO of 0 to 15%, CaO of 0 to 15%, SrO₂ of 0 to 15%, BaO of 0 to 15%, and ZrO₂ of 0 to 8%.

(Functional Layer 130)

The functional layer 130 includes silica. The functional layer 130 preferably includes silica of 50 mass % or more.

The functional layer 130 includes, for example, a matrix formed from silica precursor and including silica as a main component (in the following, referred also to as “silica-based matrix”). Silica-based matrix refers to a matrix including silica of 50% or more.

Silica-based matrix may include a component other than silica. The component includes a compound of one or more ions, oxides and/or the like selected from Li, B, C, N, F, Na, Mg, Al, P, S, K, Ca, Ti, V, Cr, Mn, Fe, Co, Ni, Cu, Zn, Ga, Sr, Y, Zr, Nb, Ru, Pd, Ag, In, Sn, Hf, Ta, W, Pt, Au, Bi, and lanthanoid elements.

The functional layer 130 may be formed only of the silica-based matrix, and may include further components other than the silica-based matrix. For example, the functional layer 130 may include particles dispersed in the silica-based matrix.

The functional layer 130 is not particularly limited as long as it can be formed from application liquid including the silica precursor and liquid medium, and includes anti-glare film, low-reflection film, deterioration prevention film for glass, alkali barrier film, anti-scratch film, antipollution film or the like.

On the surface of the functional layer 130, an arithmetic average roughness Ra is not particularly limited. The arithmetic average roughness Ra may fall within, for example, a range of 0.05 μm to 0.5 μm. The arithmetic average roughness Ra preferably falls within a range of 0.1 μm to 0.5 μm.

On the surface of the functional layer 130, a maximum height roughness Rz is preferably 3 μm or less. The maximum height roughness Rz is preferably 2 μm or less, and is more preferably 1.5 μm or less. When the maximum height roughness Rz is 3 μm or less, there are fewer convex portions on the surface, and thereby a gritty feeling is not particularly obtained when touching. Therefore, the feeling of touch can be improved.

The maximum height roughness Rz is preferable 0.5 μm or more. When the maximum height roughness Rz of the functional layer 130 is 0.5 μm or more, the function by the functional layer 130 can be expressed sufficiently.

(First Glass Member 100)

In the first glass member 100, the cut level difference RΔc expressed by above-described formula (2) may be 3% or more. The cut level difference RΔc may be, for example, 5% or more or 7% or more.

However, the cut level difference RΔc is preferably 50% or less. When the cut level difference RΔc is 50% or less, the function by the functional layer 130 can be exerted sufficiently. The cut level difference RΔc is more preferably 40% or less.

In the first glass member 100, the Martens hardness measured from the side of the functional layer 130 is 1100 N/m² or more. The Martens hardness is preferably 1200 N/m² or more, more preferably 1300 N/m² or more, and further preferably 1400 N/m² or more.

When the functional layer 130 is anti-glare film, the first glass member 100 may have a surface glossiness of 100% or less. The surface glossiness is preferably 90% or less, and more preferably 80% or less. In the embodiment, the surface glossiness is a 60° specular glossiness measured based on the method defined in JIS Z8741:199.

The first glass member 100 having the above-described configuration can be used, for example, for a cover glass of a touch panel type device.

When the functional layer of the first glass member 100 has anti-glare film, in a cover glass provided with such a first glass member 100, glare from around is suppressed and excellent feeling of touch can be obtained. Moreover, a cover glass with a great Martens hardness and resistant to scratching is provided.

(Manufacturing Method of Glass Member)

Next, with reference to FIG. 3, an example of manufacturing method for a glass member according to the embodiment will be described.

FIG. 3 depicts schematically a flow of the manufacturing method for a glass member according to the embodiment (in the following, referred to as a “first manufacturing method”).

As illustrated in FIG. 3, the first manufacturing method includes a step of applying application liquid on a first surface of a glass plate to form a functional layer including silica (step S110); a step of performing chemically strengthening treatment for the glass plate (step S120); and a step of polishing a surface of the functional layer (step S130).

A step 120 is a step that is arbitrarily conducted, and is not necessarily conducted. Moreover, in FIG. 3, the step 120 is after a step 110, and conducted before a step 130. However, different from the above, the step 120 may be conducted before the step 110 or after the step 130.

In the following, the respective steps will be described in detail. Here, for the first glass member 100 illustrated in FIG. 2 as an example, the manufacturing method thereof will be described. In addition, in the following explanation, for clarification, when expressing the respective members, the reference numerals illustrated in FIG. 2 will be used.

(Step S110)

First, a glass plate 110 used for the glass member 100 is prepared.

The glass plate 110 may be glass of any composition, and may be, for example, soda lime glass, alumino-silicate glass and alkali free glass.

Next, a functional layer 130 is formed on at least one surface (first surface 112) of the glass plate 110.

The functional layer can be formed by the following method, for example.

(Preparation of Application Liquid)

First, application liquid to be applied to the glass member 100 is prepared.

The application liquid includes at least one kind of silica precursor selected from a group including silane compound having a hydrolysable group coupled to silicon atom and hydrolysis condensate thereof and liquid medium. The application liquid may further include, as necessary, a particle, terpene compound, additive or the like.

(Silica Precursor)

The silica precursor includes silane compound (A1) having hydrocarbon group coupled to silicon atom and hydrolysable group and hydrolysis condensate thereof, alkoxysilane (except for silane compound (A1)) and hydrolysis condensate thereof (sol-gel silica), or the like.

In the silane compound (A1), the hydrocarbon group coupled to silicon atom may be a monovalent hydrocarbon group coupled to one silicon atom, or a divalent hydrocarbon group coupled to two silicon atoms. The monovalent hydrocarbon group includes alkyl group, alkenyl group, aryl group or the like. The divalent hydrocarbon group includes alkylene group, alkenylene group, arylene group or the like.

The hydrocarbon group may include a group or a combination of two or more groups selected from —O—, —S—, —CO—, and —NR′— (where R′ is a hydrogen atom or a monovalent hydrocarbon group) between carbon atoms.

The hydrolysable group coupled to a silicon atom includes alkoxy group, acyloxy group, ketoxime group, alkenyloxy group, amino group, aminoxy group, amide group, isocyanate group, halogen atom or the like. Among them, in view of a balance between stability of a silane compound (A1) and ease of hydrolyzing, alkoxy group, isocyanate group and halogen atoms (especially chlorine atoms) are preferable.

As the alkoxy group, a carbon number which is 1 to 3, is preferable, and methoxy group or ethoxy group is more preferable.

When a plurality of hydrolysable groups are present in silane compound (A1), the hydrolysable groups may be the same groups or different groups, but are preferably the same groups in view of ease of obtaining.

Silane compound (A1) includes, a compound expressed by formula (5) which will be described later, alkoxy silane having alkyl group (methyl-trimethoxy silane, ethyl triethoxy silane or the like), alkoxy silane having vinyl group (vinyl-trimethoxy silane, vinyl-triethoxy silane or the like), alkoxy silane having epoxy group (2-(3,4-epoxy-cyclohexyl) ethyl-trimethoxy silane, 3-glycidoxy propyl trimethoxy silane and 3-glycidoxy propyl methyl diethoxy silane, 3-glycidoxy propyl triethoxy silane, or the like), alkoxy silane having acryloyloxy group (3-acryloyloxy propyl trimethoxy silane, or the like), or the like.

As a silane compound (A1), the compound expressed by formula (5) is preferable, because even when a film thickness is great, a crack or a film peeling hardly occurs in the functional layer 130,

R₃₋ₚLₚSi-Q-SiLₚR₃₋ₚ formula (5)

In formula (5), Q is divalent hydrocarbon group (which may include a group or a combination of two or more groups selected from —O—, —S—, —CO—, and —NR′— (where R′ is a hydrogen atom or a monovalent hydrocarbon group) between carbon atoms). The divalent hydrocarbon includes the above-described ones.

As Q, alkylene group, a carbon number of which is 2 to 8, is preferable, in view of ease of obtaining and because even when a film thickness is great, a crack or a film peeling hardly occur in the functional layer 130, and alkylene group, a carbon number of which is 2 to 6, is more preferable.

In formula (5), L is hydrolysable group. The hydrolysable group includes the above-described ones, and also in the preferred embodiment.

R is hydrogen atom or monovalent hydrocarbon group. The monovalent hydrocarbon includes the above-described ones.

In formula (5), p is an integer of 1 to 3. In view of reaction rate which becomes not too slow, p is preferably 2 or 3, and especially 3 is preferable.

Alkoxy silane (but, other than the silane compound (A1)) includes tetra alkoxy silane (tetra methoxy silane, tetra ethoxy silane, tetra propoxy silane, tetra butoxy silane, or the like), alkoxy silane having perfluoropolyether base (perfluoropolyether triethoxy silane or the like), alkoxy silane having perfluoroalkyl base (perfluoro ethyl triethoxy silane, or the like), or the like.

Hydrolysis and condensation of silane compound (A1) and alkoxy silane (but, other than silane compound (A1)) can be performed by a known method.

For example, in a case of tetra alkoxy silane, the reaction is performed using water of four times mol of the tetra alkoxy silane, and acid or alkali as catalyzer.

The acid includes inorganic acid (HNO3, H2SO4, HCl, or the like), organic acid (formic acid, oxalic acid, monochloroacetic acid, dichloroacetic acid, trichloroacetic acid, or the like. The alkali includes ammonia, sodium hydroxide, potassium hydroxide, or the like. As the catalyzer, acid is preferable in view of long-term preserving property of hydrolysis condensate of silane compound (A).

As the silica precursor, one kind may be used independently, or two kinds may be combined and used.

The silica precursor includes preferably any one or both of silane compound (A1) and hydrolysis condensate thereof in view of prevention of a crack or film peeling of the functional layer 130.

The silica precursor includes preferably any one or both of tetra alkoxy silane and hydrolysis condensate thereof in view of wear resistance strength of the functional layer 130.

The silica precursor includes particularly preferably any one or both of silane compound (A1) and hydrolysis condensate thereof and any one or both of tetra alkoxy silane and hydrolysis condensate thereof.

(Liquid Medium)

Liquid medium dissolves or disperses silica precursor, and is preferably a solvent that dissolves the silica precursor. When the application liquid includes particles, liquid medium may also have a function as dispersion medium that disperses the particles.

The liquid medium includes water, alcohols, ketones, ethers, cellosolves, esters, glycol ethers, nitrogen-containing compound, sulphur-containing compound, or the like.

The alcohols include methanol, ethanol, isopropanol, 1-butanol, 2-butanol, isobutanol, diacetone alcohol, or the like.

The ketones include acetone, methylethyl ketone, methyl isobutyl ketone, or the like.

The ethers include tetrahydrofuran, 1,4-dioxane, or the like.

The cellosolves include methyl cellosolve, ethyl cellosolve, or the like.

The esters include methyl acetate, ethyl acetate, or the like.

The glycol ethers include ethylene glycol mono alkyl ether, or the like.

The nitrogen-containing compound includes N,N-dimethyl acetamide, N,N-dimethyl formamide, N-methyl pyrolidone, or the like.

The sulphur-containing compound includes dimethyl sulfoxide, or the like.

One kind of liquid medium may be used independently, or two kinds may be combined and used.

Because water is required for hydrolysis of alkoxy silane or the like in silica precursor, the liquid medium includes at least water unless the liquid medium is replaced after the hydrolysis.

In this case, the liquid medium may be only water, or mixed liquid of water and another liquid. The other liquid includes alcohols, ketones, ethers, cellosolves, esters, glycol ethers, nitrogen-containing compound, sulphur-containing compound, or the like. Among the other liquids, as a solvent for silica-based matrix precursor, alcohols are preferable, and methanol, ethanol, isopropyl alcohol, 1-butanol, 2-butanol, isobutanol are particularly preferable.

The liquid medium may include acid or alkali. Acid or alkali may be added upon preparing a solution of silica precursor as a catalyzer for hydrolysis or condensation of a raw material (alkoxy silane or the like), or may be added after the preparation of the solution of silica precursor.

(Particles)

When the application liquid includes particles, depending on kind or compounded amount of the particles, characteristics (refraction index, transmissivity, color tone, conductive property, wettability, physical durability, chemical durability, or the like) can be controlled.

The particles include inorganic particles, organic particles, or the like. Material of the inorganic particles includes metal oxide, metal, alloy, inorganic pigment, or the like. The metal oxide includes Al₂O₃, SiO₂, SnO₂, TiO₂, ZrO₂, ZnO, CeO₂, SnOₓ including Sb (ATO), In₂O₃ including Sn (ITO), RuO₂, or the like.

The metal includes Ag, Ru or the like. The alloy includes AgPd, RuAu or the like. The inorganic pigment includes titanium black, carbon black, or the like. Material of the organic particles includes organic pigment, resin, or the like. The resin includes polystyrene, melanin resin or the like.

A shape of the particles includes special shape, elliptical shape, needle shape, plate shape, rod shape, conical shape, cylindrical shape, cubic shape, rectangular parallelepiped shape, diamond shape, star shape, undefined shape, or the like. Solid inorganic particles may be present in a state where the respective particles are independent from each other, respective particles are connected in a chain state, or the respective particles are agglomerated.

The particles may be solid particles, hollow particles, or perforated particles such as porous particles. The term “solid” indicates that a hollow is not present inside. The term “hollow” indicates that a hollow is present inside.

As the particles, one kind may be used independently, or two kinds may be combined.

As the particles, solid inorganic particles are preferable in view of cost, ease of obtaining, or the like, and solid metal oxide particles are more preferable in view of chemical durability.

Solid inorganic particles may be combined with other particles.

When forming low-reflection film (antireflection film) as the functional layer 130, solid silica particles are preferably included as the solid inorganic particles.

As the solid silica particles, chain-like solid silica particles are preferable. The chain-like solid silica particles are solid silica particles having a chain-like shape. For example, the chain-like solid silica particles include particles having a form in which a plurality of solid silica particles having spherical shape, elliptical shape, needle shape, or the like are coupled in chains. The form of the chain-like solid silica particles can be confirmed by an electron microscope.

Chain-like solid silica particles can be obtained as commercial items. Moreover, products manufactured by the known method of manufacturing may be used. The commercial item includes, for example, SNOWTEX ST-OUP of Nissan Chemical Industries, LTD., or the like.

An average agglomerated particle diameter of the particles is preferably 5 to 300 nm, and more preferably 5 to 200 nm. When the average agglomerated particle diameter of the particles is the lower limit of the range or more, blending effect of the particles can be easily exerted. When the average agglomerated particle diameter is the upper limit or less, the functional layer 130 is excellent in mechanical characteristics such as abrasion resistance.

The average agglomerated particle diameter is measured on volumetric basis by a laser diffraction type particle size distribution measurement device.

(Terpene Compound)

Terpene compound is preferably used when the application liquid includes particles. When the application liquid includes terpene compound along with particles, an air gap is formed around a particle in the functional layer 130, and thereby the refraction index of the functional layer 130 tends to be lower compared with a case not including terpene compound.

Terpene means hydrocarbon of a composition of (C₅H₈)ₙ (where n is an integer greater than or equal to 1) in which isoprene (C₅H₈) is a constituent unit. Terpene compound means terpenes having a functional group derived from terpene. Terpene compound also includes the one having different degree of unsaturation.

In addition, although terpene compound includes the one that functions as a liquid medium, “hydrocarbon of a composition of (C₅H₈)ₙ in which isoprene (C₅H₈) is a constituent unit” shall correspond to terpene derivative, but shall not correspond to a liquid medium.

As terpene compound, terpene derivative disclosed in WO 2010/018852 or the like may be used.

(Additive Agent)

As the additive agent, a variety of known additive agents may be used. For example, surfactant agent for improving levelling property, metal compound for improving durability, ultraviolet absorbing agent, infrared reflection/infrared absorbing agent, antireflection agent or the like is included.

Surfactant agent includes silicone oils, acrylic or the like.

Metal compound is preferably zirconium chelated compound, titanium chelated compound, aluminum chelated compound or the like. Zirconium chelated compound includes zirconium tetra-acetyl acetonate, zirconium tributoxy stearate, or the like.

(Composition)

When a contained amount of silica precursor (in SiO₂ equivalent) in an application liquid is 15 mass % or more with respect to solid content in terms of oxide in the application liquid, is more preferably 20 mass % or more, and is further preferably 25 mass % or more.

When the contained amount of silica precursor (in SiO₂ equivalent) is 15 mass % or more with respect to solid content in terms of oxide, a sufficient adhesion strength between the chemically strengthened glass plate 110 and the functional layer 130 can be obtained.

An upper limit of the contained amount of silica precursor (in SiO₂ equivalent) with respect to solid content in terms of oxide is not particularly limited, and may be 100 mass %. The upper limit can be properly set depending on contained amount of other component blended in the application liquid as necessary.

The contained amount of the liquid medium in the application liquid shall be an amount depending on solid content concentration of the application liquid.

The solid content concentration of the application liquid, for total amount of the application liquid (100 mass %), is preferably 1 to 6 mass %, and more preferably 2 to 5 mass %. When the solid content concentration is greater than or equal to the lower limit of the range, an amount of liquid of the application liquid used for forming the functional layer 130 can be reduced. When the solid content concentration is less than or equal to the upper limit of the range, a uniformity of a film thickness of the functional layer 130 is improved.

The solid content concentration of the application liquid is a sum of contained amounts of all components other than the liquid medium in the application liquid. However, a contained amount of component including metallic element is an amount in terms of oxide.

When the application liquid includes solid inorganic particles, a contained amount (in terms of oxide) of solid inorganic particles in the application liquid, for solid content in terms of oxide (100 mass %) in the application liquid, is preferably 10 to 85 mass %, more preferably 20 to 80 mass %, and particularly preferably 30 to 75 mass %. When the contained amount of the solid inorganic particles is greater than or equal to the lower limit of the range, sufficient blending effect of the solid inorganic particles is obtained. For example, when the solid organic particles are solid silica particles, a refraction index of the functional layer 130 is reduced, and a sufficient effect of enhancing transmissivity can be obtained. When the contained amount of the solid inorganic particles is less than or equal to the upper limit of the range, the functional layer 130 is excellent in mechanical strength such as abrasion resistance.

The application liquid may include hollow silica particles as particles, or may not include. However, the contained amount (in SiO₂ equivalent) of hollow silica particles in the application liquid shall be, for solid content in terms of oxide in the application liquid, less than 10 mass %, preferably less than 7 mass %, and more preferably 5 mass %. When the contained amount of hollow silica particles is, for solid content in terms of oxide, less than 10 mass %, the glass member 100 can be manufactured at low cost.

The application liquid can be prepared by, for example, preparing a solution in which silane precursor is dissolved in a liquid medium, and mixing as necessary additional liquid medium, dispersion liquid of particles, terpene compound, other arbitrary component, or the like.

(Formation of Functional Layer 130)

Next, the application liquid prepared as above is applied on the glass plate 110. Afterwards, the application liquid is desiccated, and thereby the functional layer 130 is formed. The desiccation process may be performed by heating, or may be performed without heating but by natural drying, air drying or the like.

After the desiccation process, a calcination process may be performed as necessary. The calcination process is performed by, for example, heating the glass plate 110 at 100 to 450° C.

According to the above-described processes, the functional layer 130 including silica can be formed on the glass plate 110.

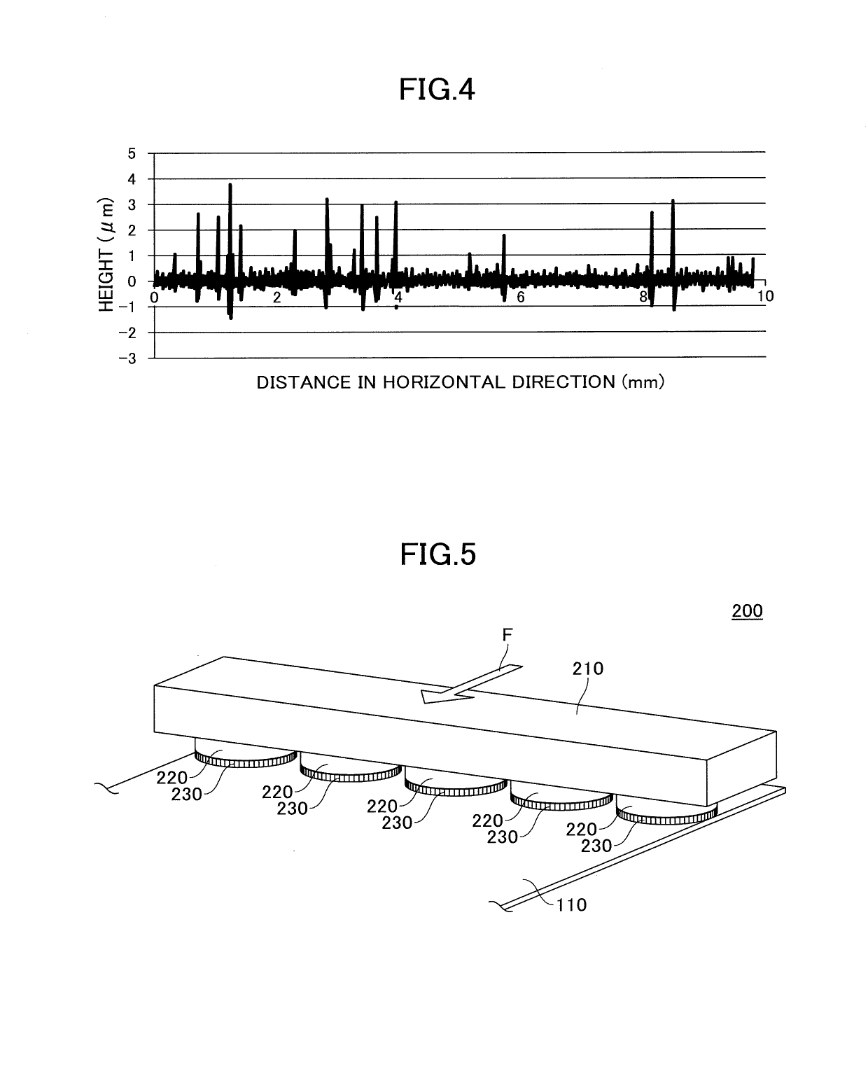

FIG. 4 is a diagram depicting an example of a surface roughness profile of the functional layer 130 formed as above.

As illustrated in FIG. 4, on a surface of the functional layer 130, a lot of convex portions projecting in a “spike-like” form can be found. At this stage, the cut level difference RΔc, as defined above, is less than 2%.

In this way, it is necessary to note that on the surface of the functional layer 130 formed at step S110, a lot of convex portions projecting in a “spike-like” form are present, and an excellent feeling of touch has not been obtained yet.

(Step S120)

Next, when necessary, the glass plate 110 including the functional layer 130 is subjected to chemically strengthening treatment.

Condition for the chemically strengthening treatment is not particularly limited. The chemically strengthening treatment may be performed by, for example, immersing the glass plate 110 in melted potassium nitrate heated at 350 to 500° C.

In addition, the process S120 for performing the chemically strengthening treatment may be executed after the step S130 or before the step S110. The step S120 is preferably performed after the step S110 and before the step S130, or after the step S130. Accordingly, the heat treatment for the functional layer 130 can be performed simultaneously with the chemically strengthening treatment for the glass plate 110. When the process S120 is performed before the process S110, the heat treatment for the functional layer 130 is preferably performed after the step S110.

(Step S130)

Next, a polishing process is performed on a side of the functional layer 130 of the glass plate 110. Therefore, a surface that satisfies the cut level difference RΔc≧2%, i.e. a surface having an excellent feeling of touch is formed.

Condition for the polishing process is not particularly limited as long as the cut level difference RΔc defined as above satisfies RΔc≧2% in the surface roughness curve of the functional layer 130 obtained as above.

The polishing process may be performed by, for example, a polishing device as illustrated in FIG. 5.

FIG. 5 schematically illustrates an example of the polishing device that is used when the surface of the functional layer 130 is polished.

As illustrated in FIG. 5, the polishing device 200 includes a brush unit 210. On the brush unit 210, a plurality of disk-like brushes 220 are arranged along a line, and to a downward direction. On the bottom of each brush 220, a polishing sheet 230 is arranged. On the polishing sheet 230, abrasive grains for polishing are fixed by resin.

When the polishing process is performed for the functional layer 130 of the glass plate 110 by using the above-described polishing device 200, the glass plate 110 is arranged on the lower side of the brush unit 210. An entire length of an array of the brushes 220 forming the brush unit 210 is preferable greater than the width of the glass plate 110.

Next, when the brush unit 210 is moved downward toward the glass plate 110, each brush 220 enters into a state of contacting the functional layer 130 of the glass plate 110.

When each brush 220 of the brush unit 210 is rotated in this state, the surface of the functional layer 130 of the glass plate 110 is polished by the polishing sheet 230 of each brush 220. On this occasion, washing water may be supplied on the surface of the glass plate 110 to wash the surface of the glass plate 110 simultaneously with the polishing.

Next, the brush unit 210 is moved along the surface of the glass plate 110 (along the direction indicated by the arrow F). Alternatively, the glass plate 110 may be moved for the brush unit 210 in an opposite direction of the arrow F.

According to the above-described operations, the surface of the functional layer 130 of the glass plate 110 can be polished. Moreover, by the above-described steps, the glass member according to the embodiment can be manufactured.

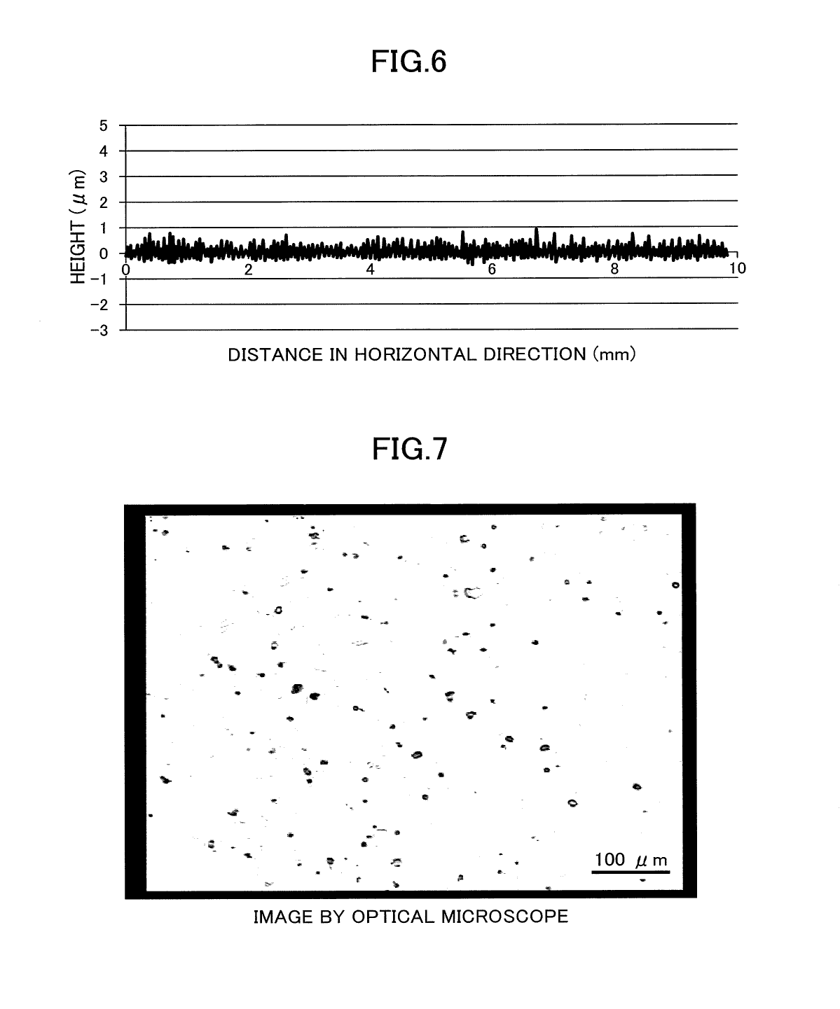

FIG. 6 illustrates an example of a surface roughness profile of the functional layer 130 after the step S130.

As illustrated in FIG. 6, on the functional layer 130 after the polishing, the convex portions projecting in a “spike-like” form, as recognized in FIG. 4, are found to have disappeared. At this stage, the cut level difference RΔc, as defined above, is greater than or equal to 2%.

In this way, because convex portions projecting in a “spike-like” form are not present, an excellent feeling of touch can be obtained.

Moreover, from comparison of FIG. 4 and FIG. 6, the surface of the functional layer 130 after the step S110 (FIG. 4) is found to have almost the same property as the surface of the functional layer 130 after the step S130 (FIG. 6) except for the convex portions projecting in a “spike-like” form. In other words, the surface of the functional layer 130 at step S130 (FIG. 6) can be said to have a concave-convex profile obtained by removing convex portions projecting in a “spike-like” form from the surface of the functional layer 130 after step S110 (FIG. 4).

Result of the comparison as above indicates that a concave-convex part of the functional layer 130 other than the convex portions projecting in a spike-like form changes little (i.e. is not polished). In this case, also an occurrence of change in the function expressed by the functional layer 130 can be said to be little by performing the polishing process at step S130.

In this way, in the first manufacturing method, the convex portions projecting in a “spike-like” form can be selectively removed without degrading the function of the functional layer 130.

Here, the cut level difference RΔc of the functional layer 130 obtained after the step S130 is preferably three times the cut level difference RΔc of the functional layer 130 obtained after the step S110 or more, and more preferably five times or more. This property means that most of the convex portions projecting in a “spike-like” form are preferentially removed at step S130.

Moreover, when the polishing process is performed, instead of free abrasive grains, fixed abrasive grains are preferably used. Here, the “free abrasive grains” means, for example, abrasive grains that are dispersed into water or oil (slurry) impregnated in a medium such as sponge. When the polishing process is performed, positions among free abrasive grains in slurry easily change. On the other hand, the “fixed abrasive grains” means abrasive grains fixed to a medium. When the polishing process is performed, positions against the medium do not move, and positions among fixed abrasive grains do not move. The fixed abrasive grains include, for example, alumina particles arranged on a sheet of paper or a cloth. For example, the polishing sheet 230 illustrated in FIG. 5 is a sheet having fixed abrasive grains.

By polishing the functional layer 130 using fixed abrasive grains, only convex portions projecting in a “spike-like” form become able to be preferentially removed easily with changing little the concave-convex property of the average roughness. That is, a surface that satisfies the cut level difference RΔc≧2% becomes able to be formed relatively easily.

### EXAMPLE

Next, an example of the present invention will be described. In the following description, a first example, a third example, a fifth example, and a seventh example are comparative examples, and a second example, a fourth example and a sixth example are examples.

### First Example

A glass member is manufactured by the following method.

A glass plate (soda lime glass) having a size of 100 mm long, 100 mm wide and 1.1 mm thick is prepared.

Next, on one surface of the glass plate, a functional layer (anti-glare film) is formed by the following method.

(Preparation of First Silica Precursor Solution)

Mixed liquid of ion-exchange water of 11.9 g and nitric acid of 0.1 g (61 mass %) is added while stirring to denatured ethanol of 75.8 g (Solmix AP-11: Japan Alcohol Trading Co., Ltd., mixed solvent where main agent is ethanol, the same hereinafter), and the stirring is continued as it is for five minutes. Tetraethoxysilane of 12.2 g (concentration of solid content in terms of SiO₂: 29 mass %) is added to the solution, which is stirred for 30 minutes at the room temperature, and thereby silica precursor solution where concentration of solid content in terms of SiO₂ is 3.5 mass % (in the following, referred to as “a-1 precursor solution”) is prepared.

Here, the concentration of solid content in terms of SiO₂ is a concentration of solid content when all Si in tetraethoxysilane are converted into SiO₂.

(Preparation of Second Silica Precursor Solution)

Mixed liquid of ion-exchange water of 7.9 g and nitric acid of 0.2 g (61 mass %) is added while stirring to denatured ethanol of 80.3 g, and the stirring is continued as it is for five minutes. Next, 1,6-bis (trimethoxysilyl) hexane (KBM 3066: Shin-Etsu Silicone Co., Ltd., concentration of solid content in terms of SiO₂: 37 mass %) is added to this solution, and the solution is stirred for 15 minutes at 60° C. in a water bath. Then, silica precursor solution where concentration of solid content in terms of SiO₂ is 4.3 mass % (in the following, referred to as “a-2 precursor solution”) is prepared.

Here, the concentration of solid content in terms of SiO₂ is a concentration of solid content when all Si are converted into SiO₂.

(Preparation of Application Liquid)

The a-2 precursor solution of 7.0 g is added while stirring to the a-1 precursor solution of 77.1 g, and mixed liquid is stirred for 30 minutes. Next, denatured ethanol of 15.9 g is added to the mixed liquid at room temperature, and the mixed liquid is stirred for 30 minutes. Then, an application liquid where concentration of solid content in terms of SiO₂ is 3.0 mass % is obtained.

(Formation of Anti-Glare Film)

The above-described glass plate is heated preliminarily by a preheating furnace (VTR-115: Isuzu Seisakusho, Ltd.) at 90° C. Next, in a state where a temperature at a surface of the glass plate is maintained at 90° C., the application liquid is sprayed on the glass plate. Condition of the spray application is as follows:

Spray pressure: 0.2 MPa;

Nozzle moving speed: 750 mm/min; and

Spray pitch: 22 mm.

For a nozzle, a VAU nozzle (Spraying Systems Co. Japan) is used.

Afterwards, the glass plate is subjected to a desiccation treatment for 30 minutes at 180° C.

According to the above-described processes, a glass member having an anti-glare film (thickness of 1 μm to 2 μm) formed of silica on a glass plate is obtained. The glass member will be referred to as sample 1.

### Second Example

A glass member is manufactured by the same method as the first example. However, in the second example, a polishing process is further performed for sample 1.

The polishing process is performed using the polishing device 200 as illustrated in FIG. 5, described as above. On the bottom face of the disk-like brush 220 in FIG. 5, an alumina abrasive grain sheet having particle diameter of 2 μm is arranged. The rotational speed of the brush 220 is set to 100 rpm. When sample 1 is polished, a forced pressing pressure is not applied to sample 1 and the brush 220 (Therefore, a pressing distance is greater than 0 mm, but less than 0.5 mm).

The polishing process is performed for a surface of the anti-glare film of sample 1.

The glass member manufactured in this way will be referred to as sample 2.

### Third Example

In a third example, a glass member is manufactured by the same method as the first example, except that condition for preparation of the application liquid is changed as follows.

(Preparation of Application Liquid)

The a-2 precursor solution of 5.4 g is added, while stirring, to the a-1 precursor solution of 68.5 g, and the mixed liquid is stirred for 30 minutes.

Next, denatured ethanol of 26.1 g is added to the mixed liquid at the room temperature, and the mixed liquid is stirred for 30 minutes. Then, an application liquid where concentration of solid content in terms of SiO₂ is 2.3 mass % is obtained.

The glass member manufactured in this way will be referred to as sample 3.

### Fourth Example

A glass member is manufactured by the same method as the third example. However, in the fourth example, a polishing process is further performed for sample 3.

The polishing process is performed with the condition used in the second example.

The glass member manufactured in this way will be referred to as sample 4.

### Fifth Example

A glass member is manufactured by the same method as the first example. However, in the fifth example, after forming the anti-glare film, a chemically strengthening treatment is further performed for the glass member.

The chemically strengthening treatment is performed by immersing sample 1 in molten salt of potassium nitrate at 420° C. for 150 minutes.

The glass member manufactured in this way will be referred to as sample 5.

### Sixth Example

A glass member is manufactured by the same method as the fifth example. However, in the sixth example, a polishing process is further performed for sample 5.

The polishing process is performed with the condition used in the second example.

The glass member manufactured in this way will be referred to as sample 6.

### Seventh Example

The same glass plate (soda lime glass) as the glass plate used in the first example is prepared.

Next, a functional layer (anti-glare film) is formed on one surface of the glass plate by the following method.

(Preparation of Third Silica Precursor Solution)

Mixed liquid of ion-exchange water of 11.9 g and nitric acid of 0.1 g (61 mass %) is added while stirring to denatured ethanol of 79.3 g (Solmix AP-11: Japan Alcohol Trading Co., Ltd., mixed solvent where main agent is ethanol, the same hereinafter), and the stirring is continued as it is for five minutes. Vinyltrimethoxysilane of 8.7 g (concentration of solid content in terms of SiO₂: 40.5 mass %) is added to the solution, which is stirred for 30 minutes at the room temperature, and thereby silica precursor solution where concentration of solid content in terms of SiO₂ is 3.5 mass % (in the following, referred to as “b-1 precursor solution”) is prepared.

Here, the concentration of solid content in terms of SiO₂ is a concentration of solid content when all Si in vinyltrimethoxysilane are converted into SiO₂.

(Preparation of Application Liquid)

The a-2 precursor solution of 7.0 g is added while stirring to the b-1 precursor solution of 77.1 g, and mixed liquid is stirred for 30 minutes. Next, denatured ethanol of 15.9 g is added to the mixed liquid at room temperature, and the mixed liquid is stirred for 30 minutes. Then, an application liquid where concentration of solid content in terms of SiO₂ is 3.0 mass % is obtained.

Using the application liquid obtained as above, an anti-glare film is formed by the same method as in the first example.

The glass member manufactured in this way will be referred to as sample 7.

In the following table 1, the manufacture conditions for the respective samples are illustrated collectively.

TABLE 1

| | | chemically | | |
|---|---|---|---|---|
| | | strengthening | functional film | polishing |
| sample | glass plate | treatment | (anti-glare film) | process |
| 1 | soda lime glass | no | silica | no |
| 2 | soda lime glass | no | silica | yes |
| 3 | soda lime glass | no | silica | no |
| 4 | soda lime glass | no | silica | yes |
| 5 | soda lime glass | yes | silica | no |
| 6 | soda lime glass | yes | silica | yes |
| 7 | soda lime glass | no | silica | no |

(Evaluation)

(Measurement of Surface Roughness Profile)

For respective samples 1 to 7 manufactured by the above-described methods, surface roughness profiles of the functional layers are measured by using a stylus type flatness meter (Surfcom 1400D: Tokyo Seimitsu Co., Ltd.). Moreover, the cut level difference RΔc expressed by above-described formula (2), the maximum height roughness Rz and the arithmetic average roughness Ra are measured. Measurement lengths L for samples are 10 mm, respectively.

(Evaluation of Anti-Glare Properties)

For respective samples manufactured by the above-described methods, anti-glare properties are evaluated.

The evaluation of anti-glare properties is performed by measuring 60° specular glossiness at a central portion of the anti-glare film of each sample.

The 60° specular glossiness is measured by using a gloss meter (Nippon Denshoku Industries Co., Ltd., PG-3D type) and by the method specified in JIS Z8741:1997.

Measurement result in which the 60° specular glossiness is 100% or less is determined to be a sample where the anti-glare property is good.

(Evaluation of Haze Value)

For respective samples, haze values are measured by using a haze meter (Hz-2: Suga Test Instruments Co., Ltd.).

(Evaluation of Feeling of Touch)

For respective samples, feeling of touch for anti-glare film is evaluated. When evaluating, an evaluator actually touches a surface of the anti-glare film of sample with a finger, and evaluates an obtained feeling on a three point scale (scabrous; normal; and flat).

(Measurement of Martens Hardness)

For respective samples, Martens hardness is measured from a side of the anti-glare film. For the measurement, a Picodentor hardness tester (HM-500; Fischer Instruments K.K.) is used. Indentation load when measuring is set to 0.03 mN/5 s, and indentation depth is set to 9.6 nm.

Moreover, when measuring the Martens hardness, ηIT (%) is also measured. Here, ηIT is a kind of an index of brittleness evaluation. The smaller the value of ηIT is, the greater brittleness is and it can be said to be brittle.

The index ηIT (%) can be calculated from a resilient behavior when an indenter is pressed into the functional layer. More specifically, ηIT (%) can be calculated from the formula (5), specified in ISO 15477, as follows:

ηIT (%)=Wₑₗₐₛₜ (N·m)/Wₜₒₜₐₗ (N·m) formula (5)

where Wₑₗₐₛₜ is an elastic reverse deformation work of indentation (N·m) and Wₜₒₜₐₗ is a total mechanical work of indentation (N·m).

(Results)

Table 2 collectively illustrates results of the respective evaluation test obtained for respective samples.

TABLE 2

| | | | | anti- | | | | |
|---|---|---|---|---|---|---|---|---|
| | | | | glare | haze | | Martens | |
| sam- | RΔc | Rz | Ra | prop- | value | feeling | hardness | ηIT |
| ple | (%) | (μm) | (μm) | erty | (%) | of touch | (N/mm²) | (%) |
| 1 | 1.09 | 5.22 | 0.161 | good | 12.1 | scabrous | 1389 | 78.9 |
| 2 | 9.66 | 1.36 | 0.116 | good | 10.8 | flat | 1403 | 76.2 |
| 3 | 1.00 | 2.95 | 0.108 | good | 6.1 | scabrous | 1434 | 89.4 |
| 4 | 26.46 | 0.70 | 0.072 | good | 5.3 | flat | 1441 | 82.6 |
| 5 | 1.09 | 5.22 | 0.161 | good | 10.3 | scabrous | 1892 | 80.0 |
| 6 | 9.66 | 1.36 | 0.116 | good | 9.6 | flat | 1880 | 80.2 |
| 7 | 0.48 | 1.76 | 0.127 | good | 6.7 | normal | 1007 | 73.2 |

As illustrated in Table 2, the cut level differences RΔc of sample 1, sample 3, sample 5, and sample 7 are found to be small and less than 2%. In contrast, the cut level difference RΔc of sample 2, sample 4, and sample 6 are found to be 2% or more.

Moreover, the maximum height roughness Rz of sample 1 and sample 5 is 5 μm or more, and exhibit comparatively great values. In contrast, the maximum height roughness Rz of samples 2, 4, 6, and 7 is less than 2 μm. In addition, regarding the arithmetic average roughness Ra, great difference is not found among samples 1 to 7.

Regarding the anti-glare properties, an excellent result is obtained for each sample.

Moreover, from the evaluation result for the feeling of touch, excellent feelings of touch are found to be obtained for sample 2, sample 4, and sample 6, whereas the feelings of touch for sample 1, sample 3 and sample 5 are not good.

In addition, although the feeling of touch for sample 7 is somewhat inferior as compared with sample 2, sample 4, and sample 6, sample 7 exhibits better feeling of touch than sample 1, sample 3 and sample 5. Moreover, for sample 7, the anti-glare property is excellent.

However, sample 7 is considered to have a problem in strength and brittleness. That is, for sample 7, Martens hardness is about 1000 N/mm² that is the smallest, and the value of ηIT is also the smallest.

In other words, for samples 1 to 6, Martens hardness is greater than 1100 N/mm², and samples 1 to 6 are found to have great strength compared with sample 7. Moreover, for samples 1 to 6, ηIT is comparatively high, and samples 1 to 6 are found to have excellent brittleness.

When a glass member is assumed to be applied to a cover glass or the like of a touch panel type device, characteristic of being resistant to scratching (abrasion resistance) is also required for such glass plate. From such a standpoint, sample 2, sample 4, and sample 6 can be said to be more preferable than sample 7.

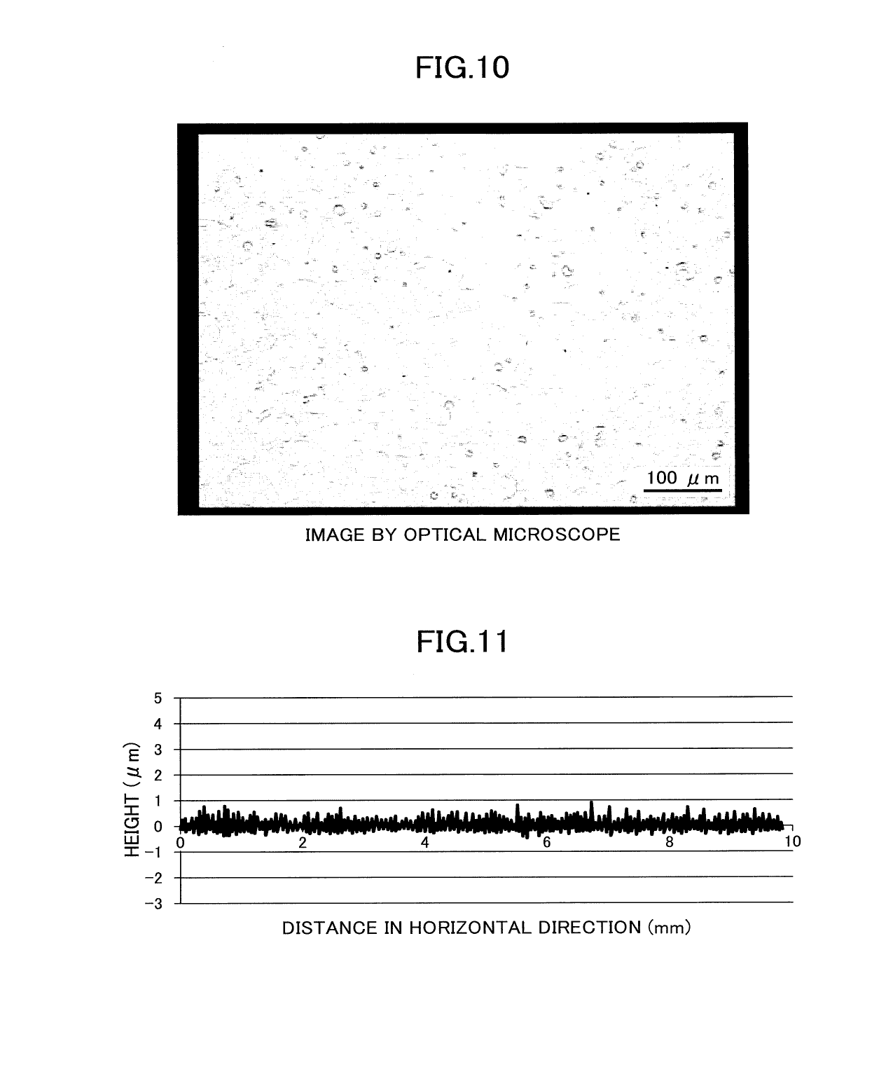

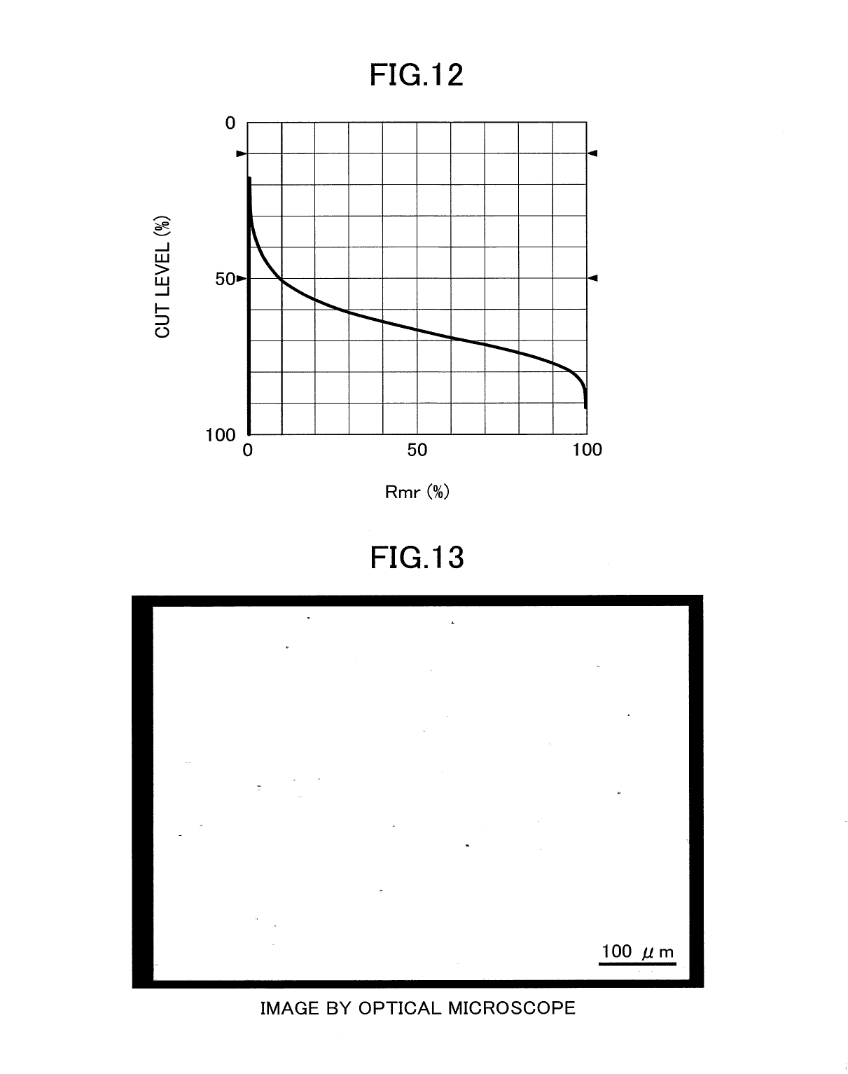

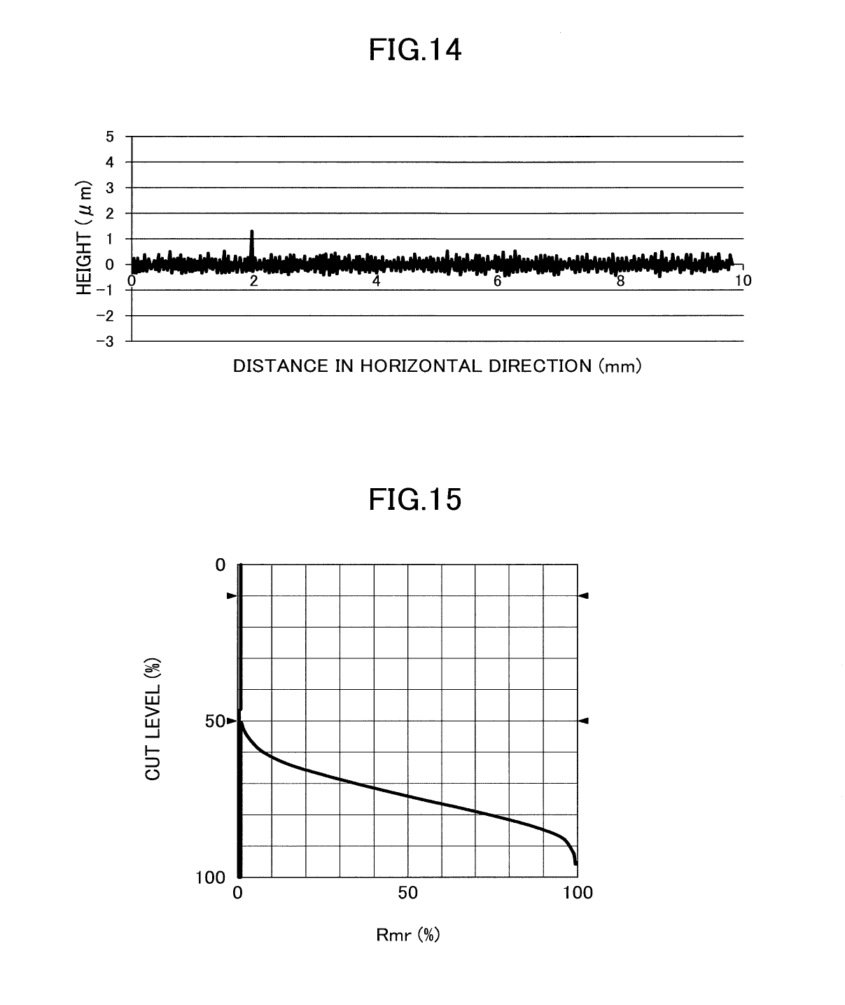

FIGS. 7 to 9 illustrate respectively a photograph of anti-glare film in sample 1 by a surface microscope, a surface roughness profile of the anti-glare film, and a relation between a cut level c of the anti-glare film and a load length ratio Rmr(c). Similarly, FIGS. 10 to 12 illustrate respectively a photograph of anti-glare film in sample 2 by the surface microscope, a surface roughness profile of the anti-glare film, and a relation between a cut level c of the anti-glare film and a load length ratio Rmr(c). Moreover, FIGS. 13 to 15 illustrate respectively a photograph of anti-glare film in sample 7 by the surface microscope, a surface roughness profile of the anti-glare film, and a relation between a cut level c of the anti-glare film and a load length ratio Rmr(c).

From the results, in sample 1, a lot of spike-like projected convex portions are found to occur on the surface of the anti-glare film. On the other hand, in sample 2, a spike-like projected convex portion is not recognized on the surface of the anti-glare film. Moreover, in sample 7, slightly spike-like projected convex portions are recognized on the surface of the anti-glare film.

In addition, in the photographs of surface illustrated in FIGS. 7 and 10, in sample 2, compared with sample 1, parts visible as blackish dots are reduced. Therefore, the parts visible as blackish dots in the photographs of surface are considered to correspond to spike-like projected convex portions, respectively. In sample 2, when performing a polishing process for sample, the spike-like projected convex portions are removed. Then, compared with sample 1, the parts visible as blackish dots are considered to be reduced. Moreover, because sample 7 includes such a small spike-like projected convex portion originally, in the photograph of surface in FIG. 13, the same surface aspects as sample 2 are considered to be observed.

These surface aspects correspond to the evaluation results for the cut level difference RΔc and the feeling of touch. That is, as a number of spike-like projected convex portions present on the surface of the anti-glare film increases, RΔc decreases and the feeling of touch degrades. Conversely, as the number of spike-like projected convex portions present on the surface of the anti-glare film decreases, RΔc increases and the feeling of touch is improved.

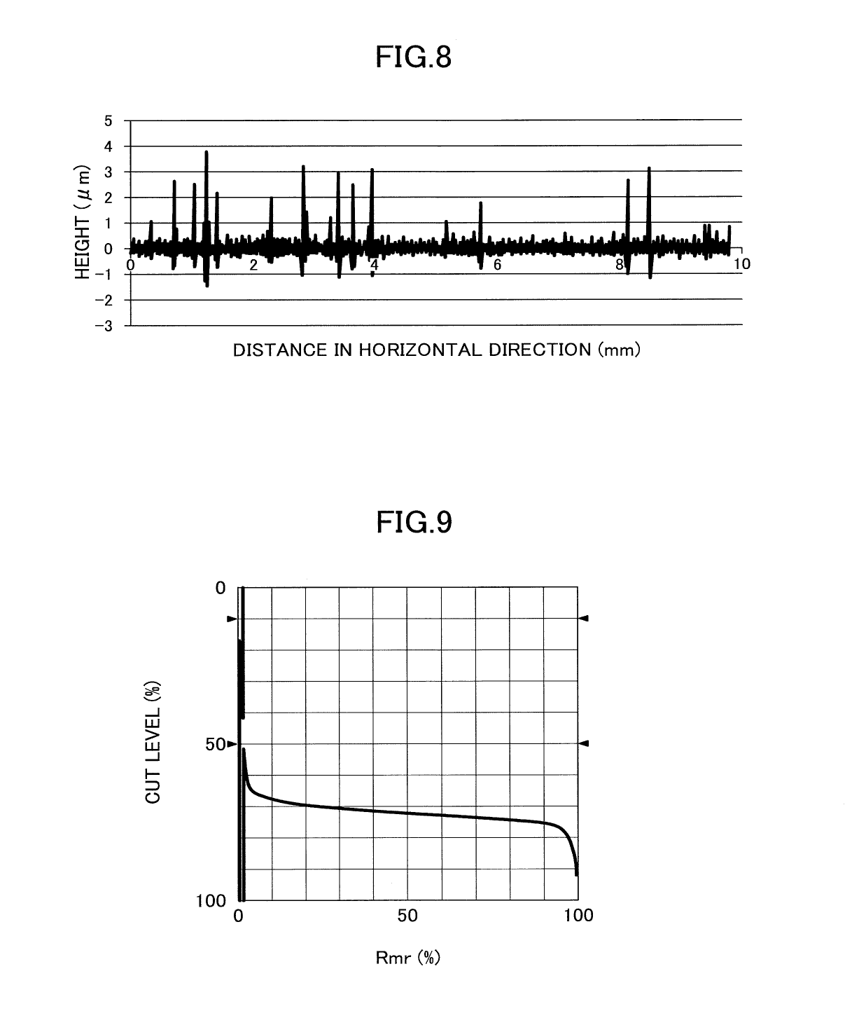

From comparison of FIG. 8 with FIG. 10, despite difference from sample 1 that the spike-like projected convex portions are removed in sample 2, little change is found to occur in the other surface profiles. That is, in the polishing process employed in the embodiment, only the spike-like projected convex portions are removed, and the other part is little polished. Then, as a result of such polishing process, in sample 2, the same anti-glare property as sample 1 is considered to be obtained (i.e. the anti-glare property is not degraded). Moreover, for the same reason, in sample 4, the same anti-glare property as sample 3 is considered to be obtained, and in sample 6, the same anti-glare property as sample 5 is considered to be obtained (i.e. the anti-glare property is not degraded).

In this way, by polishing a surface of a functional layer (anti-glare film) having a surface profile with a cut level difference RΔc of less than 2%, to make the cut level difference RΔc greater than or equal to 2%, feeling of touch is recognized to be improved without degrading a function. Moreover, in such a glass member, an appropriate Martens hardness is found to be obtained, and the glass member is found to have an excellent abrasion resistance.

As described above, the present invention is explained based on the respective embodiments. However, the present invention is not limited to these embodiments, but various variations and modifications may be made without departing from the scope of the present invention.

What is claimed is:

1. A glass member comprising a glass plate, on a first surface of which a functional layer is formed,
wherein a Martens hardness measured from a side of the functional layer of the glass member is 1100 N/mm² or more, the functional layer including silica, and
wherein a cut level difference RΔc obtained from a roughness curve for a surface of the functional layer is 2% or more,
the cut level difference RΔc being obtained by subtracting a load length ratio for a cut level of 10%, Rmr(10), from the load length ratio for the cut level of 50%, Rmr(50),
the load length ratio for the cut level c being obtained by formula
$$Rmr ( c ) = \frac{1}{L} {\sum }_{i = 1}^{n} {M ( c )}_{i} \times 100$$
where M(c)ᵢ is a cut length of an i-th cut portion,
n cut portions being obtained by cutting the roughness curve at the cut level c within a region having a length L.

2. The glass member according to claim 1,
wherein the functional layer includes the silica of 50 mass % or more.

3. The glass member according to claim 1,
wherein the glass plate is made of soda lime glass or alumino-silicate glass.

4. The glass member according to claim 1,
wherein the glass plate is chemically strengthened.

5. The glass member according to claim 1,
wherein a surface glossiness of the functional layer is 100% or less.

6. A manufacturing method of glass member, which includes a glass plate, comprising:
applying application liquid on a first surface of the glass plate to form a functional layer including silica, to make a cut level difference RΔc obtained from a roughness curve for a surface of the functional layer less than 2%; and
polishing the surface of the functional layer, to make the cut level difference RΔc obtained from the roughness curve for the surface of the functional layer 2% or more,
the cut level difference RΔc being obtained by subtracting a load length ratio for a cut level of 10%, Rmr(10), from the load length ratio for the cut level of 50%, Rmr(50),
the load length ratio for the cut level c being obtained by formula
$$Rmr ( c ) = \frac{1}{L} {\sum }_{i = 1}^{n} {M ( c )}_{i} \times 100$$
where M(c)ᵢ is a cut length of an i-th cut portion,
n cut portions being obtained by cutting the roughness curve at the cut level c within a region having a length L.

7. The manufacturing method of glass member according to claim 6,
wherein the cut level difference RΔc obtained after polishing the surface of the functional layer is five times the cut level difference RΔc obtained before polishing the surface of the functional layer or more.

8. The manufacturing method of glass member according to claim 6,
wherein the surface of the functional layer is polished by using fixed abrasive grains.

9. The manufacturing method of glass member according to claim 6 further comprising:
performing a chemically strengthening treatment for the glass plate on which the functional layer is formed.

10. The manufacturing method of glass member according to claim 9,
wherein the chemically strengthening treatment is performed after applying the application liquid on the first surface of the glass plate but before polishing the surface of the functional layer, or the chemically strengthening treatment is performed after polishing the surface of the functional layer.
